(19) United States
(12) Patent Application Publication
(10) Pub. No.: US 2013/0161054 A1
(43) Pub. Date: Jun. 27, 2013

(54) Security/Tether Cable

(71) Applicants: Thaine Allison, Hillsboro, OR (US); Donald Niderost, Hillsboro, OR (US); Ron Peters, Hillsboro, OR (US)

(72) Inventors: Thaine Allison, Hillsboro, OR (US); Donald Niderost, Hillsboro, OR (US); Ron Peters, Hillsboro, OR (US)

(73) Assignee: MERCHANDISING TECHNOLOGIES, INC., Hillsboro, OR (US)

(21) Appl. No.: 13/332,877

(22) Filed: Dec. 21, 2011

(51) Int. Cl. H01B 7/06

(52) U.S. Cl. 174/69

(57) ABSTRACT

A power/security cord for use in a retail display includes the combination of at least one spring steel strand and at least one conductor coiled into the shape of a “curly-Q” cord. The steel strand provides a physical barrier against cutting the cord. The conductor provides wiring for power.

### TECHNICAL FIELD

This invention relates to the cords that are used to tether electronic products to displays in retail locations.

### BACKGROUND OF THE INVENTION

Tethered product displays have evolved in the retail market along with the evolution of technology from shoulder-carried camcorders to tablet devices and smart phones. The typical “big box” retailer has one or more display locations inside the store with an array of hand-held devices mounted to a countertop (or similar surface) at individual post positions. In some cases, the product is mounted to the post such that it cannot be lifted. More commonly, the product is tethered so that the consumer can lift the product and examine it, and thereafter, return it to rest on the countertop surface.

With respect to the latter situation, different types of tethered systems have evolved in the art. One of the more common types is a reeled, multi-conductor cable. The thin-gauge copper wires within this type of cable provide a certain degree of physical security against cutting, although primary security in this type of system involves providing electrical power to theft sensors that are triggered when power is cut. Alternatively, reeled steel cables have been used, mostly during the early beginnings of retail/hand-held security systems. This older type of system generally provides only physical security because the typical braided steel cable is difficult to cut. A third type of security/tether cable is a “curly-Q” cable, somewhat like the one that is common to older telephones and similar configurations. This last kind of cable offers extension and retraction of the cord (via the coils in the cord) without a reel. However, like the reeled, multi-conductor cable described above, it is also easy to cut because there is little more than thin-gauge copper wires inside the coils.

U.S. Pat. No. 7,592,548 describes a security cable having a central metal cord surrounded by a spiral wrap of electrical conductors. While this design combines the physical security of a steel cord with the need to have wiring inside the tether, it cannot be made to work in a “curly-Q” configuration where tether extension and retraction comes from coils that are closely spaced (i.e., like a coil spring).

The invention described here is an improvement over the types of power-security cords described above.

### SUMMARY OF THE INVENTION

The invention is an improved power/security cord for use in a retail display. It includes a continuous length of spring steel next to at least one conductor that is surrounded by an exterior cord sheath. The steel provides cut-resistance but is arranged within the cord so as to provide a balance between cut resistance and flexibility.

In one embodiment, the combination of spring steel and conductor are coiled into the shape of a “curly-Q” cord with the coils of the cord providing elastic extension and retraction for respectively removing and returning displayed product (e.g., a tablet device or smart phone) to and from a retail display. As indicated, the spring steel coils provide physical security that makes it difficult to cut the cord without losing the normal extension and retraction of a curly-Q cord.

In this respect, the reader needs to bear in mind that the invention is specifically designed for use as a tether in a retail display where electronic products are sold. The tether needs to function in a situation where the consumer lifts and returns the product relative to the display during the course of handling the product (e.g., looking at particular cell phone or smartphone model the customer is interested in purchasing). Adding spring steel within a curly-Q cord structure involves altering the normal spring forces of the cord—which likewise alters the amount of “pull” that the consumer needs to put on the tether to pull the product away from the display. The spring coils need to be stiff or strong enough to return the cord to the fully retracted state—with coils tightly packed against each other. At the same time, the spring forces created via the use of steel in the cord cannot be of a magnitude such that pulling on the cord and holding the product while the cord is extended becomes noticeably difficult to the consumer. Within this balance, there needs to be sufficient thickness of the steel material so that it is difficult to cut (for security purposes). It should be noted that “spring steel” is just one of many cut resistant materials that could be used. Other metals, certain plastics, (e.g., Kevlar), etc. might be used as an alternative to increase the difficulty of cutting the security cord.

The separate conductor wire inside the coiled cord provides a means for transmitting electrical power through the cord that can be used to provide power to the hand-held or power the various kinds of security sensors that are often attached to the hand-held. The latter is conventional in that it is common to use one or more electrical conductors in a tether cable for electrically powering devices and security sensors at the same time, with the security sensors providing alarm generation means for creating an audio or visual alarm signal when the sensor is removed or the applicable conductor wire in power/security cord is cut. In the present case, the steel is included in the cord as a separate form of mechanical form of security that adds to electrical security alarm systems.

While the above implementation is described as using “spring steel” within a “curly-Q” configuration, it is to be understood that alternative implementations can be realized using other configurations of steel strands and multi-conductor combinations, described in this document. The issue involves the difficulty of combining steel wire with low gauge electrical wire in a tether designed to be used in retail security displays. The curly-Q cord is one type of known tether design, except there is no evidence in the prior art, known to applicant, that the prior art teaches how to embed steel coils in a curly-Q cord with low gauge conductor wires to create a useful tether that works for the consumer (i.e., is easy to pull and hold) but provides the retailer with desired security against theft.

It may be possible to provide the same kind of functionality in a non-curly-Q cord situation (i.e., a reeled retractor) by using a prearranged number of steel cable strands relative to a prearranged number of conductor cords within the matrix of the cord. In this respect, in one of the embodiments described below, the power/security cord could consist of a four (or less or more) conductor design that is a “non-coiled” configuration—the number of conductors corresponding to the number of electrical circuits that are desired for providing power and security at the hand-held level. The conductors are interwoven with or run parallel to thin steel strands within the cable. Striking a proper balance between steel and conductors in this type of design might allow production of a cable that can be put on a small reel, thus providing the same functionality as prior art, reeled retractors, but with the added mechanical security of steel.

Regardless of the implementation, the number and arrangement of steel strands and conductors in the cable can be tailored to meet the need for the specific retail tether implementation. In situations where an even larger number of conductors is desired (e.g., six conductors as an example), it may be desirable to include some type of central filler core.

According to yet another aspect of the design described here, and regardless of the specific power/security cord implementation (i.e., coiled or non-coiled) the conductors need protection against strain relief, which is now provided by the steel that is embedded in the cord. In other words, it is typical to use RJ12 connectors at each end of a power/security cord for easily connecting or disconnecting the cord to and from electrical boards in mounting platforms or other types of mounting devices. As indicated above, the power/security cord is usually designed to permit a consumer to lift a hand-held from a retail display surface, examine it, and then return it to the display. The forces acting on the cord during these movements will place significant strain on the typical RJ12 connector (or other kinds of wire-to-wire connections)—which can cause electrical problems and/or malfunctions in the security system. In accordance with the invention, therefore, adding steel to the cord enables using the ends of the steel strands to provide strain relief in a security tether in the retail market. As will become apparent from the following description, this is accomplished by capturing the ends of the steel cable independently from the electrical end connections of the cable.

The foregoing summary will become more clear upon review of the following detailed description, which is to be taken in conjunction with the drawings.

### BRIEF DESCRIPTION OF THE DRAWINGS

In the drawings, like reference numerals and letters refer to like parts throughout the various views, and wherein:

FIG. 1 is a pictorial view of a coiled power/security cord in accordance with the invention;

FIG. 2 is a side view of the coiled power/security cord in accordance with the invention;

FIG. 3 is a side cross-sectional view, showing how the coiled power/security cord connects to a housing;

FIG. 4 is a side view showing a specific retail display where the coiled power/security cord might be used;

FIG. 5 is a view showing alternative uses of the coiled power/security cord;

FIG. 6 is a cross-sectional view of coiled or non-coiled versions of the power/security cord in accordance with the invention

FIG. 7 is a view similar to FIG. 6, but shows yet another embodiment;

FIG. 8 is a pictorial view similar to FIG. 3, but shows how cord strain relief is implemented;

FIG. 9 is an enlargement of the pictorial view shown in FIG. 8 and illustrates how a strain-relief ferrule is captured in a fixture;

FIG. 10 is a view similar to FIG. 9, but with the strain-relief ferrule missing; and

FIG. 11 is a schematic showing an alternative embodiment of the power/security cord described here, and illustrates how a non-coiled version of the cord may be used in connection with a reeled configuration.

### DETAILED DESCRIPTION

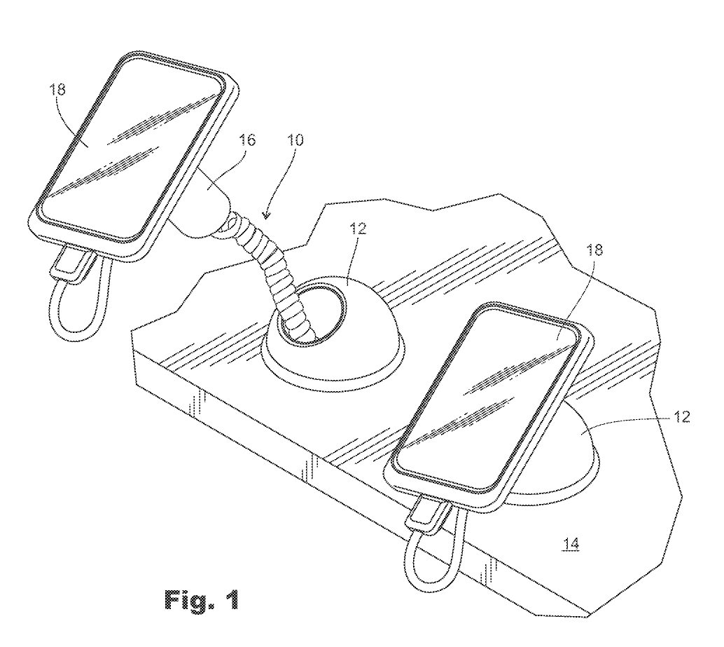

Referring now to the drawings, and first to FIG. 1, shown generally at 10 is an improved power/security cord constructed in accordance with one embodiment. The cord 10 shown in FIG. 1 extends out from a countertop housing 12 mounted to a top surface 14 of a display countertop. The cord 10 connects under-the-counter electronics to a mounting member 16 that is attached to a smart phone or similar electronic hand-held device 18. On the right-hand side of FIG. 1, the hand-held 18 is shown returned to a resting position on part 12.

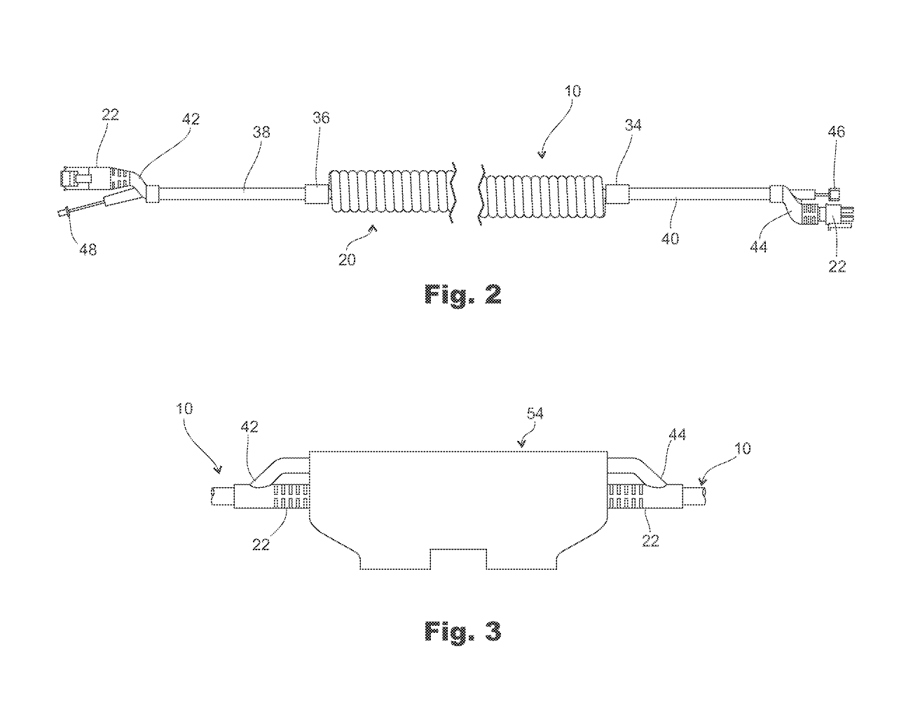

Referring now to FIG. 2, the general construction of the power/security cord 10 will now be described. Outwardly, this embodiment takes the form of a “curly-Q” cord having a multiple number of coils (the coils are “tight” when cord 10 is relaxed), as indicated generally at 20. Overall, looking at the outside, this general construction would be familiar. The specific construction details that are different (the interior of the cord and strain relief features) are discussed below.

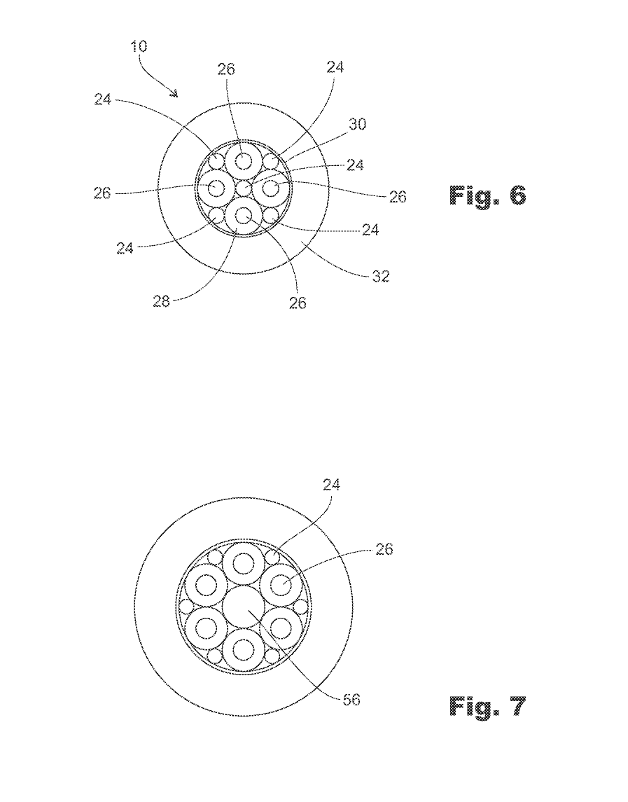

Each end of the power/security cord 10 has a conventional electrical connector 22 (e.g., RJ12 connector) which would be familiar to a person skilled in the art. Directing attention briefly to FIG. 6 (a cross-sectional view of cord 10), the interior of the cord 10 consists of a number of spring steel strands, each one of which is indicated by numeral 24. Also inside the FIG. 6 embodiment are a plurality of conductors (wires), each one indicated by numeral 26. Each conductor 26 is surrounded by its own insulation 28.

The combination of steel strands 24 and conductors 26 are collectively surrounded by a thin sheath 30; which is further surrounded by an exterior sheath 32. This interior configuration represents the span between the opposite ends 22 of the cord 10 shown in FIG. 2, including the coiled portion 20.

Turning to FIG. 2, the coiled portion 20 is terminated on each end by conventional ABS wire clips 34, 36. Outwardly of the coiled portions are non-coiled (straight) portions 38, 40, respectively. These portions 38, 40 terminate in molded fittings 42, 44 that lead to end connectors 22. While described as “straight” it is to be understood that these portions are not necessarily “stiff.” They are flexible.

The steel strands 24 inside the coils 20 continue through the straight portions 38, 40 and exit, with each end terminated by a brass ferrule and washer fitting 46, 48. This arrangement relieves the strain on the electrical end connectors 22 that are branched away from ferrule/washer 46, 48.

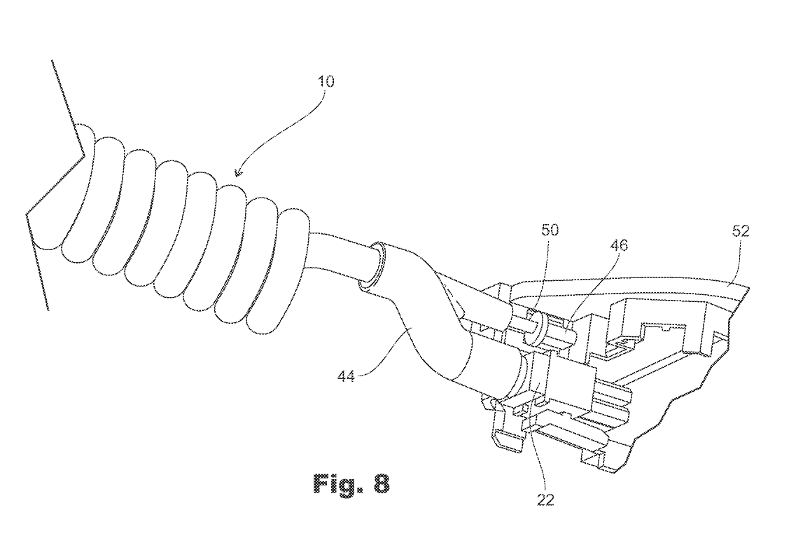

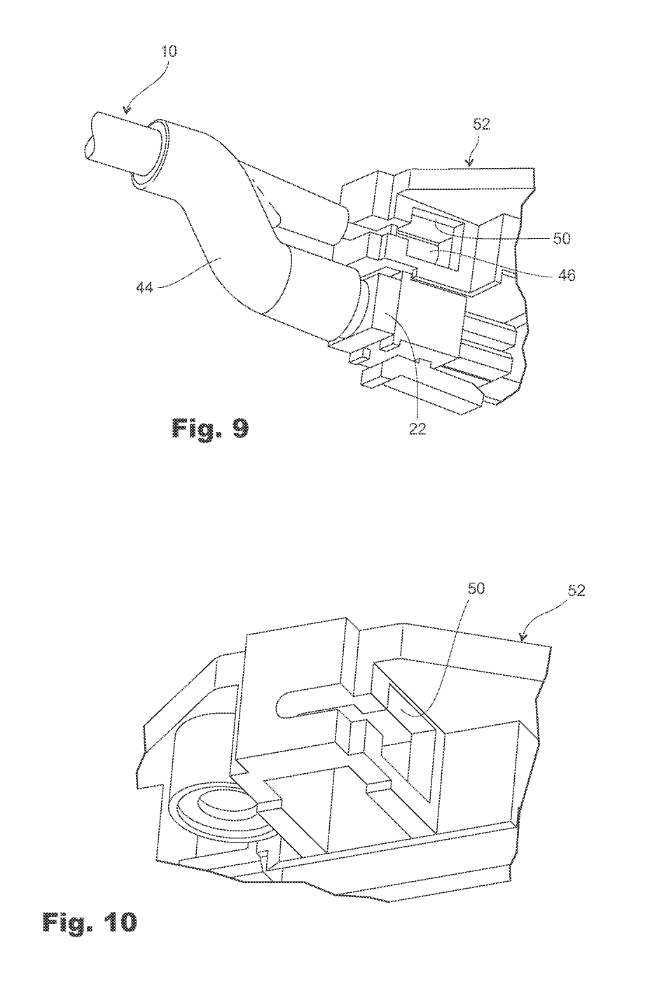

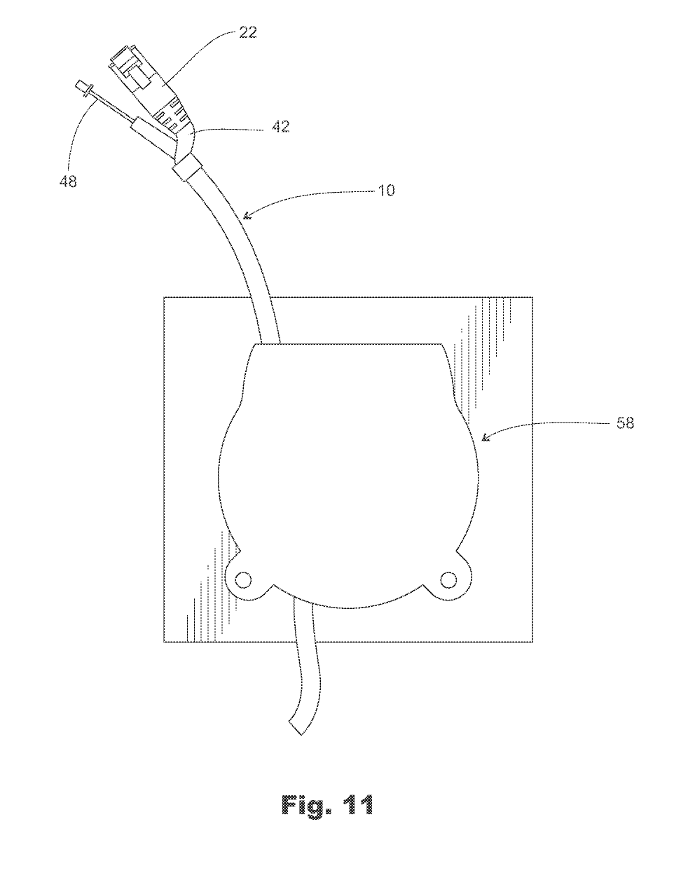

More specifically, and referring now to FIG. 8, the ferrule/washer combination 46, 48 are fit into a recess 50 in a housing 52 to which the cord 10 is connected. The recess 50 is better seen in FIG. 10.

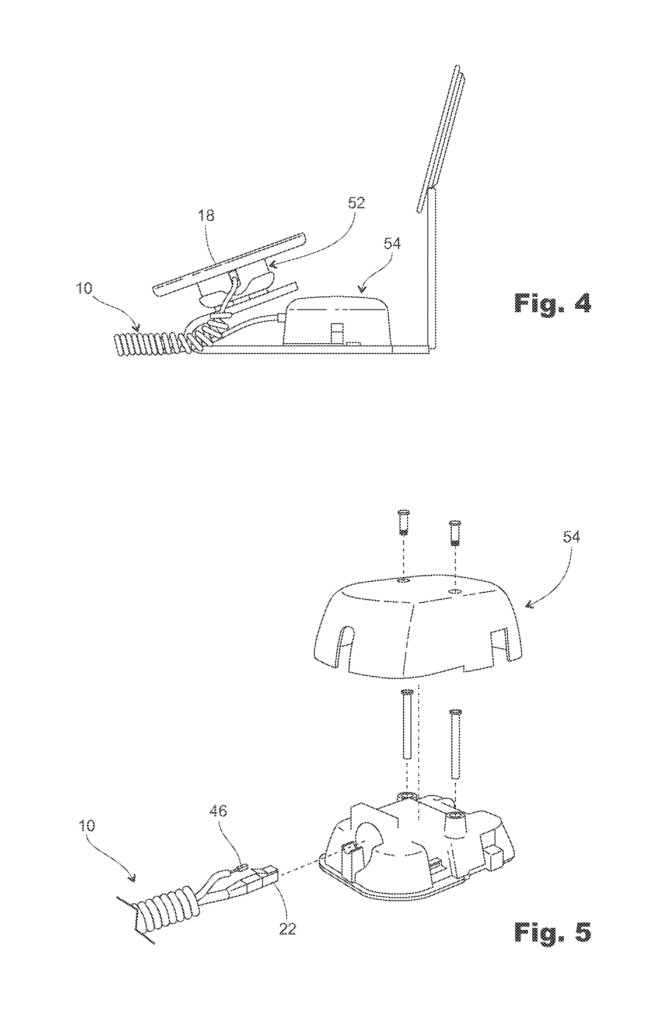

The housing 52 might be the same as item 16 in FIG. 1 or it could be a different kind of mounting member like, for example, the surface anchor generally indicated at 54 in FIG. 5. FIG. 3 is a side view that shows how two cords 10 might plug into opposite sides of a housing 52. FIG. 4 shows yet another kind of display arrangement where the cord 10 could be used. In any case, the recess 50 captures the ferrule/washer combination 46, 48 and allows it to relieve any strain put on connector 22 during the course of pulling the cord 10 while the consumer examines the product 18.

It is important to understand that at least one steel strand 24 is included in the cord 10 and at least one conductor 26. However, as reflected in FIG. 7, compared to FIG. 6, the numbers of steel strands 24 and conductors 26 can be a variable depending on the specific application and the desired balance between cut-resistance, flexibility, extension/retraction, and power requirements. In FIG. 7, for example, the steel strands 24 are arranged radially outwardly relative to the conductors 26. In this embodiment, the conductors 26 circle a central filler 56.

To summarize, these embodiments enable the construction of a coiled cord for use as a power/security tether in retail displays. It is anticipated that the steel strands will be made of spring steel and coiled in the shape illustrated at 20 in FIG. 2. Alternatively, it is conceivable that braided steel strands may be used in combination with conductors or it is possible an arrangement of parallel steel strands and conductors could be used. These latter two examples might be suitable for using the cord “uncoiled” on a reel—with the reel providing extension and retraction of the tether. In other words, it is conceivable that a non-coiled version of cord 10 could be housed within a conventional reel structure, schematically indicated at 58 in FIG. 11, with the strain relief on the cord's end as described above. In such case, the cord 10 would simply reel and unreel in the same way as conventional “retractors,” which are reel-based tether systems common in the art relating to retail security systems. The reel 58 schematically indicated in FIG. 11 is a common component in the retail security field and would be familiar to the skilled person. There are many examples of these kinds of reels illustrated in the patent literature.

The foregoing sets forth the best mode for carrying out the invention. Whether limited to coiled or non-coiled applications, it is to be understood that the scope of patent protection is not to be limited by the foregoing description. Instead, the scope of patent protection is to be limited only by the claim or claims that follow below.

What is claimed is:

1. For use in a retail display, a coiled power/security cord for use in connecting a displayed product to said retail display, the coiled power/security cord characterized in that it includes a continuous length of steel with a plurality of coils for enabling elastic extension and retraction of said coiled cord, for respectively removing and returning said displayed product to and from said retail display, said coiled power/security cord including at least one continuous conductor for transmitting electrical power through said coiled cord, and further, said continuous length of spring steel being adjacent to said at least one conductor, for preventing the severing of said power/security cord, and further, said steel and said at least one conductor being surrounded by an exterior cord sheath.

2. The power/security cord of claim 1, wherein said continuous length of steel includes a plurality of lengths of steel within said cord, each respective length running parallel to each other.

3. The power/security cord of claim 2, including a plurality of continuous conductors for transmitting electrical power through said cord.

4. The power/security cord of claim 3, wherein said steel lengths are positioned radially outwardly relative to said conductors.

5. The power/security cord of claim 4, including a central filler core, positioned radially inwardly with respect to said conductors and said steel lengths.

6. The power-security cord of claim 5, including an intermediate sheath surrounding said conductors and steel lengths, radially between said conductors and steel lengths, on the inside, and said outer cord sheath, on the outside.

7. The power/security cord of claim 2, wherein said steel lengths are positioned radially outwardly relative to said at least one conductor.

8. The power/security cord of claim 1, including an electrical connection at each end of said continuous conductor, and strain relief means, at each end of said steel length, for enabling said spring steel length to relieve strain on said conductor as said coiled cord is extended and retracted.

9. For use in a retail display, a power/security cord for use in connecting a displayed product to said retail display, the power/security cord characterized in that it includes a continuous length of a steel cable, for securely removing and returning said displayed product to and from said retail display, said power/security cord further including at least one continuous conductor for transmitting electrical power through said cord, and further, said continuous length of steel cable being adjacent to said at least one conductor, for preventing the severing of said power/security cord, and further, said steel cable and said at least one conductor together being surrounded by an exterior cord sheath, and further including
an electrical connection at each end of said continuous conductor, and
strain relief means, on at least one end of said steel length, for enabling said steel length to relieve strain on said conductor as said coiled cord is extended and retracted.

10. The power/security cord of claim 9, including strain relief means at each end of said steel length.

11. The power/security cord of claim 9, wherein said continuous length of steel includes a plurality of lengths of steel within said cord, each respective length running parallel to each other.

12. The power/security cord of claim 11, including a plurality of continuous conductors for transmitting electrical power through said cord.

13. The power/security cord of claim 12, wherein said steel lengths are positioned radially outwardly relative to said conductors.

14. The power/security cord of claim 13, including a central filler core, position radially inwardly with respect to said conductors and said steel lengths.

15. The power-security cord of claim 14, including an intermediate sheath surrounding said conductors and steel lengths, radially between said conductors and steel lengths, on the inside, and said outer cord sheath, on the outside.

16. The power/security cord of claim 11, wherein said steel lengths are positioned radially outwardly relative to said at least one conductor.

17. The power/security cord of claim 10, including an electrical connection at each end of said continuous conductor, and strain relief means, at each end of said steel length, for enabling said steel length to relieve strain on said conductor as said coiled cord is extended and retracted.

18. For use in a retail display, a power/security cord for use in connecting a displayed product to said retail display, the power/security cord characterized in that it includes a continuous length of a steel cable, for securely removing and returning said displayed product to and from said retail display, said power/security cord further including at least one continuous conductor for transmitting electrical power through said cord, and further, said continuous length of steel cable being adjacent to said at least one conductor, for preventing the severing of said power/security cord, and further, said steel cable and said at least one conductor together being surrounded by an exterior cord sheath, said power/security cord being housed within a reel for extension and retraction of said end, and further including
an electrical connection adjacent to at least one end of said continuous conductor, and
strain relief means, adjacent to at least one end of said steel length, for enabling said steel length to relieve strain on said conductor as said coiled cord is extended and retracted.
